(19) United States
(12) Patent Application Publication
(10) Pub. No.: US 2008/0317401 A1
(43) Pub. Date: Dec. 25, 2008

(54) Optic fiber bragg grating sensor

(76) Inventors: An-Bin Huang, Hsinchu (TW); Sheng-Chiang Kao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,395

(22) Filed: Jun. 19, 2008

(30) Foreign Application Priority Data
Jun. 22, 2007 (TW) 96122525

(51) Int. Cl. G02B 6/10

(52) U.S. Cl. 385/13; 385/12

(57) ABSTRACT

The optic fiber Bragg grating (FBG) sensor comprises of an elastic circular diaphragm and one or two FBG attached to the bottom surface of the elastic circular diaphragm. Two ends of the FBG are connected to an optic fiber for signal transmission. The FBG sensor readouts are independent of temperature fluctuation. The FBG sensor mechanism according to the present invention may be applied for various purposes such as a gauge pressure transducer, differential pressure transducer, load cell and displacement transducer with distributive capabilities.

### BACKGROUND OF THE INVENTION

1. Field of the Invention

The present invention generally relates to an optic fiber Bragg grating(FBG) sensor, and more particularly relates to an optic fiber Bragg grating sensor applied as a gauge pressure transducer, differential pressure transducer, load cell, and displacement transducer.

2. Description of the Prior Art

Conventionally, most electronic pressure sensors or electronic displacement sensors transform the applied physical quantity into an electrical current or voltage signal via various means (e.g., resistance or vibrating wire strain gages or LVDT) to facilitate the data acquisition.

Meanwhile, most electronic pressure sensors or electronic displacement sensors are of non-distributive design. Each sensing unit needs an individual signal transmission line. Therefore, the applications of such sensors are often limited by the number of transmission lines that can be accommodated in the system. Furthermore, the electronic signal may be affected by electromagnetic interference (EMI) and prone to destruction by lightning when applied in the field.

The design principles of the conventional gauge pressure sensors with optic fiber Bragg gratings (FBG), may be classified into two types. The first type-employs a mechanism to transform the sensed pressure into a stretched strain in FBG, and the strain within the FBG is uniform. Thus, the pressure can only affect the shifting of the peak FBG waveform. An important disadvantage of this design is that the reading has to be compensated for temperature variation.

The second type employs a cantilever beam to transform the sensed pressure or stress into a simultaneous pull and push strain on the opposite sides of the cantilever beam due to a load on the free end of the cantilever beam. Thus, the FBG attached to the opposite sides of the cantilever beam senses strains with the same value but of opposite signs. The physical quantity is determined based on the differential value of the two peak waveforms from the respective FBG. Another currently available method is to attach a single FBG through the neutral layer of the cantilever beam to transform the sensed pressure into a non-uniformly distributed strain within the FBG. The non-uniform strain distribution causes the FBG peak waveform to be widened or chirped. A disadvantage of this design is that the cantilever beam cannot be used to isolate the pressure chamber. A separate mechanism has to be added to make the package hermetic. The designs are more complex, and the sensitivity and linearity are compromised. Some conventional optical fiber sensors are not fabricated by using FBG, and they belong to the non-distributive design. Thus, a dedicated transmission line is required for every sensor, and its applicability and economical value are less competitive as compared to the FBG sensors.

### SUMMARY OF THE INVENTION

Other advantages of the present invention will become apparent from the following description taken in conjunction with the accompanying drawings wherein are set forth, by way of illustration and example, certain embodiments of the present invention.

An objective of the present invention is to provide an FBG sensor with a chirped or differential design, and the FBG measurement is independent from temperature variations.

Another objective of the present invention is to provide a distributive FBG sensor that can be used to serve a variety of purposes including that of gauge pressure transducer, differential pressure transducer, load cell and displacement transducer.

Therefore, it will be apparent to those of ordinary skill in the art that the present invention has at least the following advantages.

1. Multiple sensors connected in series may be installed on a single optic fiber, and the measurement quality is not affected by the number of sensors.

2. Those FBG's are attached to one side of a circular metal diaphragm. The diaphragm isolates those FBG from the chamber where pressure or force is to be applied. Meanwhile, the measured physical quantity (i.e., pressure or force) can be applied directly on the diaphragm thus enhancing the sensitivity of the measuring device. The range of the physical quantities to be sensed can be adjusted by varying the diameter and/or thickness of the diaphragm.

In accordance with the above objectives and other purposes of the present invention, an embodiment of an FBG sensor is provided, which includes an elastic circular diaphragm with its edge fixed to the transducer frame; and one or two FBG's attached to one side of the elastic diaphragm. When one FBG is used, the invention is referred to as the chirped design. In this design the center of FBG is aligned with the neutral axis of the circular diaphragm. The present invention also provides another embodiment of an FBG sensor to be referred to as the differential design. In this design, two FBG are attached to one side of the elastic diaphragm. One of those FBG is attached towards the edge of the diaphragm and the other is arranged at center of the diaphragm.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1A and FIG. 1B are a cross-sectional schematic diagram and a bottom-view diagram respectively, illustrating an FBG sensor according to the embodiment of the present invention;

FIG. 2 is a bottom-view schematic diagram illustrating an FBG sensor of the chirped design according to an embodiment of the present invention; and

FIG. 3 is a bottom-view schematic diagram illustrating an FBG sensor of the differential design according to an embodiment of present invention.

### DESCRIPTION OF THE PREFERRED EMBODIMENT

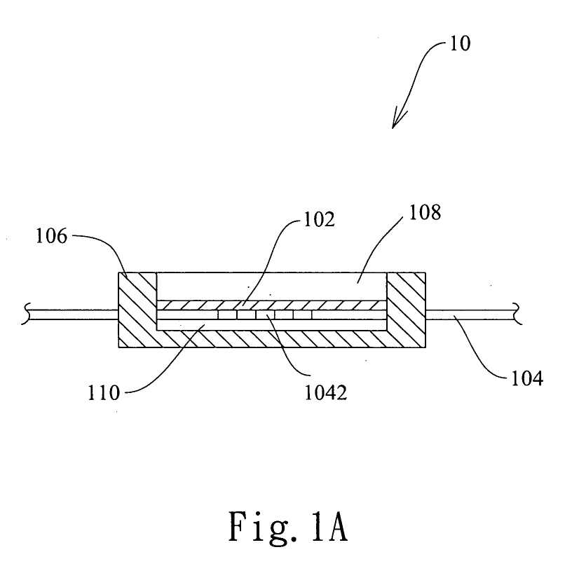

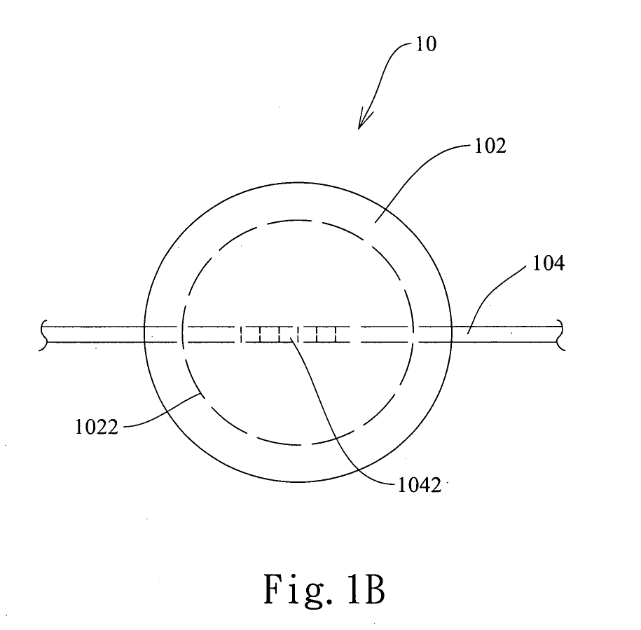

The present invention proposes attaching a single or two FBG on one side of an elastic circular diaphragm with a fixed edge. FIG. 1A and FIG. 1B are a cross-sectional schematic diagram and a bottom-view schematic diagram respectively illustrating the FBG sensor 10 according to an embodiment of the present invention. As shown in FIGS. 1A and 1B, the FBG sensor 10 includes an elastic circular diaphragm 102; and the optical fiber 104 located below the elastic circular diaphragm 102 for signals transmission. The optical fiber 104 includes at least one FBG 1042 attached on the bottom surface of the elastic circular diaphragm 102.

In an embodiment, the FBG sensor 10 further comprises a rigid shell 106, and the elastic circular diaphragm 102 and the FBG 1042 are set inside the rigid shell 106. The optical fiber 104 is passed through the rigid shell 106. In an aspect of the present invention, a space 108 located on top of the elastic circular diaphragm 102 inside the rigid shell 106 serves as a pressure chamber such that the applied external pressure or force can induce strain to the elastic circular diaphragm 102 and then to FBG 1042. In another aspect of the present invention, a space 110 located under the bottom surface of the elastic circular diaphragm 102 inside the rigid shell 106 serves as an isolation chamber. The isolation chamber is completely sealed such that the applied external pressure or force cannot pass to the FBG 1042 is not affected by the external pressure/force except when it is applied through the elastic circular diaphragm 102.

According to the theory of the plates and shells, when the elastic circular diaphragm 102 with its edge fixed, is subjected to a pressure in space 108 or compression force to cause the central portion to deform downwardly, the center part of the bottom side of the elastic circular diaphragm 102 will experience a tensile strain, and then the strain passes through a neutral circle 1022 to become compressive strain with axis symmetry near the fixed edge. Alternatively, once the space 108 above the elastic circular diaphragm 102 is subjected to a tensile force or vacuum to cause the central portion to deform upwardly, the strain distribution is reversed.

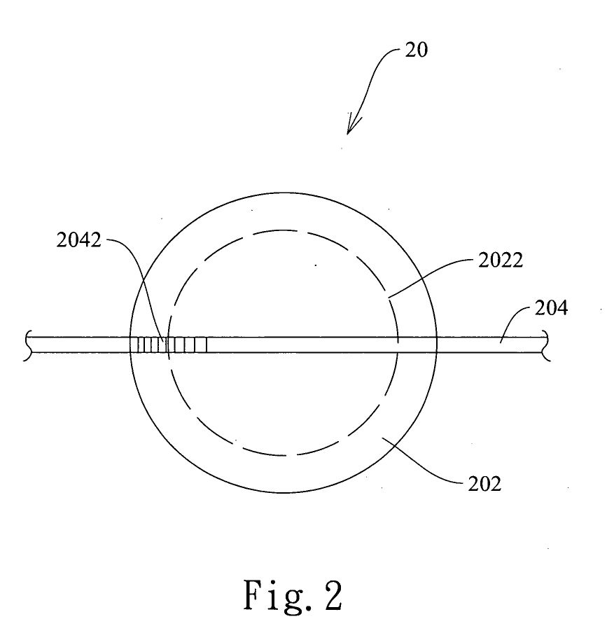

Accordingly, the sensitivity of the FBG sensor may be adjusted by changing the thickness and/or diameter of the elastic circular diaphragm. FIG. 2 is a bottom-view schematic diagram illustrating an FBG sensor 20 according to an embodiment of the present invention with chirped design. As shown in FIG. 2, the optical fiber 204 below an elastic circular diaphragm 202 includes a single chirped FBG 2042. The center of the chirped FBG 2042 is attached and aligned with a neutral circle 2022 of the elastic circular diaphragm 202. When the elastic circular diaphragm 202 is subjected a tensile or compressive pressure/force to cause a non-uniform strain distribution, a chirped strain will be induced to the chirped FBG 2042. In this case, the width of the reflective waveform from the chirped FBG 2042 is directly proportional to the pressure/force applied to the elastic circular diaphragm 202. The chirped design is suitable when diameter of the elastic circular diaphragm 202 is less than 20 mm.

On the other hand, if the radius of the diaphragm is large, for example, larger than 20 mm in diameter, the differential design that uses two FBG is more desirable.

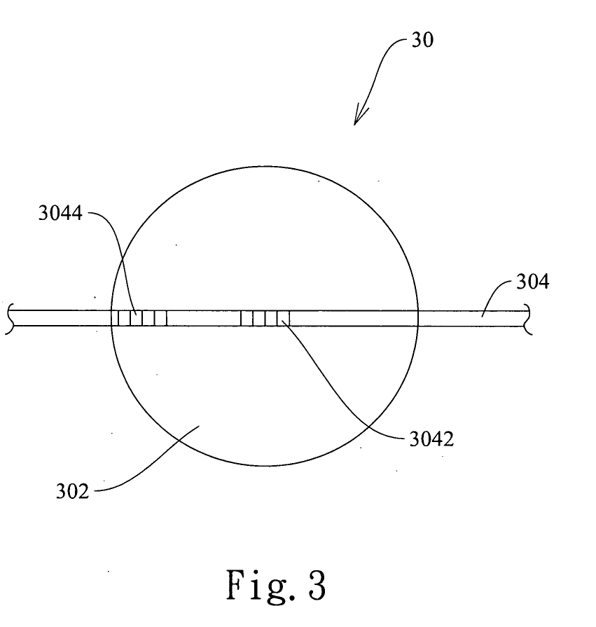

FIG. 3 is a bottom-view schematic diagram illustrating an FBG sensor 30 according to an embodiment of present invention with differential design. As shown in FIG. 3, the optical fiber 304 below the elastic circular diaphragm 302 includes a first FBG 3042 and a second FBG 3044. The central of the first FBG 3042 is attached and aligned with the center of the elastic circular diaphragm 302. The second FBG 3044 is attached on the edge of the bottom surface of the elastic circular diaphragm 302. When the elastic circular diaphragm 302 is subjected to a pressure or external force applied to the center of the elastic circular diaphragm 302, the peaks of the reflective waveforms from the two FBG will shift in opposite directions, and the differential value of the peaks is directly proportional to the pressure/force applied to the elastic circular diaphragm 302.

For the chirped design as described above, the peak of the reflective signal of the chirped FBG may be shifted due to the temperature variation, but the spectrum width is unaffected. For the differential design as described above, the peaks of the reflective waveforms from the two FBG will be shifted to simultaneously in equal amount due to the temperature variation, but the differential value is unaffected. Therefore, one of the advantages of the FBG sensor according to the present invention is that it has the option of the chirped design or differential design, and the results of both designs are independent from the temperature variations.

It will be apparent to those of ordinary skill in the art that the present invention has at least the following advantages.

1. A single optical fiber may comprise a plurality of sensors connected in series, and measurement quality is not affected by the number of measuring points.

2. The FBG strain sensors are completely isolated from the pressure/force zone so that the sensing components are well protected. Meanwhile, the pressure or force is directly applied to the diaphragm, thus with much improved sensitivity. Thus, the measuring range and sensitivity of the sensor can be adjusted by changing the diameter and/or thickness of the diaphragm.

3. For example, the FBG sensor of the present invention may be applied as a gauge pressure transducer for measuring air or liquid pressure.

In addition, the isolation chamber of the FBG sensor may be connected with a reference pressure to serve as a differential pressure transducer. Similarly, the FBG sensor can serve as a load cell where the external force is applied to the central point of the elastic circular diaphragm.

Furthermore, the FBG sensor may also serve as a displacement transducer including, for example, a pulling bar and a spring connected to the central point of the elastic circular diaphragm. The displacement value of the pulling bar is directly proportional to the reactive pulling force of the spring. As a result, the displacement value is inferred from a relationship between the FBG readings, such as the waveform signal, and the reactive force exerted on the diaphragm.

To sum up, the FBG sensor according to the present invention may be applied in many ways such as a gauge pressure transducer, a differential pressure transducer, load cell and displacement transducer with a distributive capability. Therefore, the FBG sensor may be applied in mechanical, medical science, civil engineering, national defense, and various industrial fields where stress, tensile force, compressive force, displacement, and so on are required to be measured.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An FBG sensor, comprising:
an elastic circular diaphragm; and
an optical fiber located below the elastic circular diaphragm for signal transmission, wherein the optical fiber comprises a chirped FBG attached to the bottom surface of the elastic circular diaphragm and a center of the chirped FBG is aligned with a neutral circle of the elastic circular diaphragm.

2. The FBG sensor according to claim 1, wherein a diameter of the elastic circular diaphragm is equal to or less than 20 mm.

3. The FBG sensor according to claim 1 further comprising a rigid shell, wherein the elastic circular diaphragm and the chirped FBG are set inside a rigid shell, and the optical fiber passes through the rigid shell.

4. The FBG sensor according to claim 3, wherein a space located on top of the elastic circular diaphragm inside the rigid shell serves as a pressure chamber such that the applied pressure or force can induce strain to the elastic circular diaphragm and then to the chirped FBG; wherein a space under the elastic circular diaphragm inside the rigid shell serves as an isolation chamber; and wherein the isolation chamber is completely sealed such that the chirped FBG is not affected by external pressure/force except when it is applied through the elastic circular diaphragm.

5. The FBG sensor according to claim 4, wherein the FBG sensor is a gauge pressure transducer and the isolation chamber is connected to the atmospheric pressure.

6. The FBG sensor according to claim 4, wherein the FBG sensor is a differential pressure transducer and the isolation chamber is connected to a reference pressure.

7. The FBG sensor according to claim 4, wherein the FBG sensor is a load cell and the external force is applied to the central point of the elastic circular diaphragm.

8. The FBG sensor according to claim 1, wherein the FBG sensor is a displacement transducer and a pulling bar and a spring are connected to the central point of the elastic circular diaphragm; and wherein a displacement value of the pulling bar is directly proportional to the reactive pulling force of the spring and the displacement value is inferred from a relationship between the waveform signal of the chirped FBG and the reactive pulling force exerted on the elastic circular diaphragm.

9. The FBG sensor according to claim 1, wherein the FBG sensor is a pressure transducer or a load cell.

10. The FBG sensor according to claim 1, wherein the pressure exerted to the elastic circular diaphragm causes a change in the width of the waveform reflected from the chirped FBG and the width of the waveform reflected from the chirped FBG is independent from temperature fluctuation.

11. An FBG sensor, comprising:
an elastic circular diaphragm; and
an optical fiber disposed below the elastic circular diaphragm for signal transmission, comprising:
a first FBG attached to the bottom surface of the elastic circular diaphragm, and the center of the FBG being aligned with the center of the elastic circular diaphragm; and
a second FBG attached to the edge of the elastic circular diaphragm.

12. The FBG sensor according to claim 11, wherein a diameter of the elastic circular diaphragm is equal to or larger than 20mm.

13. The FBG sensor according to claim 11, further comprising a rigid shell, wherein the elastic circular diaphragm and the first and the second FBG are set inside the rigid shell, and the optical fiber passes through the rigid shell.

14. The FBG sensor according to claim 13, wherein a space located above the elastic circular diaphragm inside the rigid shell serves as a pressure chamber such that the applied pressure or force can induce strain to the elastic circular diaphragm and then to the first FBG and the second FBG; wherein a space under the elastic circular diaphragm inside the rigid shell serves as an isolation chamber; and wherein the isolation chamber is completely sealed such that the first and second FBG are not affected by external pressure/force except when it is applied through the elastic circular diaphragm.

15. The FBG sensor according to claim 14, wherein the FBG sensor is a gauge pressure transducer and the isolation chamber is exposed to the atmospheric pressure.

16. The FBG sensor according to claim 14, wherein the FBG sensor is a differential pressure transducer and the isolation chamber is connected to a reference pressure.

17. The FBG sensor according to claim 14, wherein the FBG sensor is a load cell and the first external force applied to the center of the elastic circular diaphragm.

18. The FBG sensor according to claim 11, wherein the FBG sensor is a displacement transducer and a pulling bar and a spring connected to the center of the elastic circular diaphragm, and wherein a displacement value of the pulling bar is directly proportional to the reactive pulling force of the spring and the displacement value is inferred from a relationship between the waveform signal of the first and second FBG and the reactive pulling force exerted on the elastic circular diaphragm.

19. The FBG sensor according to claim 11, wherein the FBG sensor is a pressure transducer or a load cell.

20. The FBG sensor according to claim 11, wherein the physical quantity to be sensed is read by the difference in peak waveforms between the first FBG and the second FBG, and wherein the differential value of the peak waveforms between the first FBG and the second FBG is independent from temperature fluctuation.
